(19) United States
(12) Patent Application Publication
(10) Pub. No.: US 2007/0039879 A1
(43) Pub. Date: Feb. 22, 2007

(54) Sustainable product solution development method

(76) Inventors: Bradley R. Tate Nunn, Glenpool, OK (US); K. Joy Nunn, Bixby, OK (US); A. Michael Ghere JR., Tulsa, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/503,509

(22) Filed: Aug. 11, 2006

Related U.S. Application Data
(60) Provisional application No. 60/707,445, filed on Aug. 11, 2005.

(51) Int. Cl. C02F 3/30

(52) U.S. Cl. 210/605

(57) ABSTRACT

A method for sustainable product solution development including endorsing the waste stream supply; engaging the endorsed waste stream supply in order to identify sustainable product targets; sourcing the sustainable product targets into sustainable product solutions and maintaining the sustainable product solutions.

### CROSS REFERENCE TO RELATED APPLICATION

This application claims the benefit of copending U.S. Provisional Patent Application Ser. No. 60/707,445 entitled “METHOD FOR INDUSTRIAL MATERIAL SUSTAINABILITY”, filed Aug. 11, 2006.

### FIELD OF THE INVENTION

The present invention relates to product development methods generally, and specifically to a method for industrial material sustainability.

### BACKGROUND OF THE INVENTION

The bi-product of manufacturing processes is post-industrial manufacturing waste. This waste material is in many cases usable, high-quality material. Sometimes the waste streams from a particular industrial process can be used right back into the saved application or another application within that same industry, while other times its usage needs to be considered as an applicable regenerated product solution within another industry. These collectables are generally known as sustainable product solutions. Either case demands the application of a material identification and quantification process in order for material usage opportunities to be completely considered and appropriated.

The art of recycling waste streams to low end or same level products (i.e.“cradle to cradle”, for example: aluminum can scrap collected and sold independently or recycled to make more aluminum cans) has been established. However, the art of recycling waste streams to higher end products to be used in completely different industries/applications has not been established as a formalized product development practice. When any given waste stream cannot be regenerated and used within the same industry from which it originated, it is necessary to expand the application environment for regenerated product solutions for that waste stream. It is beneficial to then create cross-industrial corporate partnerships to support the development of the waste stream for its potential, universal (as it pertains to various industries and applications) uses.

The goal of evaluating manufacturing waste streams and engaging in industrial/cross-industrial product development efforts is to combine the quantities of similar waste stream materials that have been evaluated, collect the quantities of similar waste stream materials that have been combined, process the waste stream materials that have been collected and provide them in product form to various customers. Since sustainable product development and manufacturing is not a traditional industrial application and environmental efforts must be tangibly reported in order to be recognized, it is necessary to present verification of waste stream collection, processing and customer delivery. This is accomplished by applying standard material traceability methods in context of sustainable product manufacturing.

### SUMMARY OF THE INVENTION

The present invention is a method for developing a sustainable product solution. The sustainable product solution could be any suitable use for a waste stream supply. The waste stream supply could be generated by a single entity or multiple entities which could be related or unrelated. The waste stream supply could be a single composition, color or form, a plurality of compositions, colors, and/or forms, multiple compositions and/or aggregate compositions.

The method of the present invention includes the steps of endorsing the waste stream supply; engaging the endorsed waste stream supply in order to identify sustainable product targets; sourcing the sustainable product targets into sustainable product solutions; and maintaining the sustainable product solutions.

The present method is for the development of sustainable product solutions and for waste stream suppliers to implement which analyzes their waste stream and the sustainability of their manufactured articles as well as implements policies and procedures for minimizing the scrap waste by developing sustainable products, sustainable product customers and/or employing sustainable materials. Specifically, the method includes implementation and analysis of the types and amounts of pre-consumer scrap produces by an industrial manufacturing process and the development of a plan and procedure for the identification of ways that waste can be reused/recycled in the manufacture of useful articles or placed in the materials stream for such articles. The process also includes identification of waste streams that do not lend themselves to such reuse/remanufacture and the development of ways to eliminate those materials and substitute them with materials that are capable of reuse/remanufacture.

Further, the present invention provides a process to such industrial manufacturers which can trace their sustainable waste streams to their end use in the manufacture of other products. In the event that statutory requirements exist which require the industrial manufacturer to remain responsible for the waste associated with its manufacturing process and for the disposal of the manufactured article once its useful life has expired, the present process assists the manufacturer in determining other products which can employ their generated waste and to supply that waste to the material stream for those products. Once the product or industry is identified and the procedure for processing the waste in the materials stream for that new product or industry, the present process is capable of tracing the waste to implementation into the manufacturing of the new article. The process can then generate documentation which may be necessary for compliance with waste disposal or as proof that the waste material was, in fact, reused.

A better understanding of the present invention, its several aspects, and its advantages will become apparent to those skilled in the art from the following detailed description, wherein there is described the preferred embodiment of the invention, simply by way of illustration of the best mode contemplated for carrying out the invention.

### BRIEF DESCRIPTION OF THE DRAWINGS

FIG. 1 is a flow diagram of the process of the present invention.

FIG. 2 is a flow diagram of a second preferred embodiment of the process of the present invention including an educating step.

### DESCRIPTION OF THE PREFERRED EMBODIMENTS

Before explaining the present invention in detail, it is important to understand that the invention is not limited in its application to the details of the embodiments and steps described herein. The invention is capable of other embodiments and of being practiced or carried out in a variety of ways. It is to be understood that the phraseology and terminology employed herein is for the purpose of description and not of limitation.

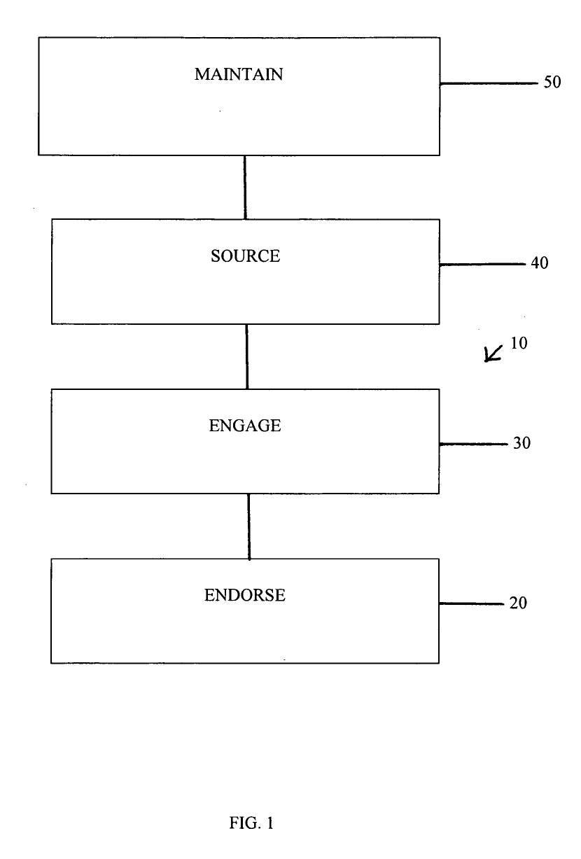

The basic preferred embodiment of the sustainable product solution development method 10 of the present invention is depicted in FIG. 1 and includes the steps of endorsing the waste stream supply; engaging the endorsed waste stream supply in order to identify sustainable product targets; sourcing the sustainable product targets into sustainable product solutions and maintaining the sustainable product solutions.

The waste stream supply may be generated from a single generator entity or multiple entities and from a single facility or multiple facilities. If the waste stream supply is generated from a single generator entity, that single generator entity may have a single facility, multiple facilities or a single or multiple sub-entities that may or may not be in the same industry but produce a waste stream supply. The method of the present invention contemplates waste stream supplies.

Reference is first mode to the endorsing step 20 of the present invention.

The focus of the endorsing phase or step 20 of the present invention includes evaluating the waste stream supply. The waste stream supply may be generated by the entities that are involved in the targeted sustainable product development areas. In this step, a novel Sustainable Supply Endorsement System may be used. This system is preferably a computer network based application that serves as the forum for gathering, comparing and sharing waste stream properties and waste stream forecast related data to support sustainable product development. The endorsing step may also include reporting the endorsed waste stream supply.

The participants in the step of endorsing preferably include, but are not limited to representatives from the sustainable product solution developer, representatives from the generator entities whose manufacturing waste stream are being evaluated as well as representatives from the related parent, master and cross-industrial development partnership companies.

The endorsement step preferably includes, but is not limited to, physically locating the available manufacturing waste streams per process at the generator entity whose waste streams supply or supplies are being evaluated, determining waste stream material properties (including but not limited to composition, color and form), determining product to waste stream relationships (how much waste is generated when one unit of a given product is manufactured) and gathering product forecast data in order calculate waste stream forecast data based on the established product to waste stream relationships.

This waste stream forecasting is indicative of a waste stream forecasting approach based on, and updating with, the real-time manufacturing schedules of a supplier, parent company or real-time purchasing schedules of a waste stream generator. Each type of waste stream forecast provides different advantages in resulting data supportive of sustainable product development.

As waste stream forecasts are calculated various reports may be generated for the waste stream supplier, parent companies and master companies by sustainable product solution generator. A directory of waste stream types and forecasts for a particular generator's operation or supply chain is made available online for the involved generator, parent and master companies. This directory is privately published for the generator online with waste stream generation forecasts that update in unison with the manufacturing schedules in their operation or supply chain as their information is periodically updated using the Sustainable Supply Endorsement System network application. Map-based reports are also provided. These reports support the logistical side of sustainable product planning and development by displaying waste types and quantities per geographical region for a specified forecast period.

The engaging phase or step 30 engages the endorsed waste stream supply to identify sustainable product target. This step may be accomplished by the sustainable product solution developer or may include representatives from the waste generator and related parent, master and cross-industrial development partnership companies in sustainable product ideation meetings. These meetings support the targeted sustainable product development opportunities resulting from waste stream materials that have been evaluated in the given industry and promote industrial and cross-industrial product development possibilities.

The participants in the engagement step include, but are not limited to, the sustainable product solution generator or representatives from the generator who is providing the service, representatives from the supplier companies whose manufacturing waste streams have been evaluated as well as representatives from the related parent, master and cross-industrial development partnership companies.

The activities in the engagement phase include but are not limited to determining the product business focus (supplier company specific product solution, parent company specific product solution, industry specific product solution or cross-industry specific product solution) and product economic focus (drop-in raw material product application, enhanced performance product application, innovative marketing product application, or industry regeneration product application) for each sustainable product development opportunity.

The sourcing step 40 includes the development of sustainable product solutions from the waste stream supply with the network of resources made available from the related parent, master and cross-industrial partnership companies.

The participants in the sourcing step include but are not limited to representatives from the waste generator who is providing the service, representatives from the supplier companies whose manufacturing waste streams have been evaluated as well as representatives from the related parent, master and cross-industrial development partnership companies.

The activities of the sourcing step include but are not limited to typical product development practices at the initial, repeatable, defined, managed and optimized maturity levels of the product development cycle for each sustainable product solution.

The maintaining step 50 is directed to the period after sustainable product solutions have been implemented such as customer for the waste stream supply and products have been fully developed and introduced into commercial production and delivery. A Sustainable Materials Traceability Method, serves to track waste stream materials through collection, processing and shipping which provides reportable proof of sustainable product delivery.

The participants in the maintaining step 50 sustain phase include but are not limited to representatives from the sustainable product solution developer, representatives from the waste stream generator, representatives from the entities where the waste stream is sent for manufacturing purposes and representatives from the companies that perform the logistics arrangements and final distribution of the end-use sustainable products.

The activities of the maintaining step 50 include but are not limited to the use of manufacturing software system modules integrated with the use of the Sustainable Supply Endorsement System module to track waste stream material forecasting, collection, processing and delivery information throughout the life of any endorsed manufacturing waste stream and related sustainable products.

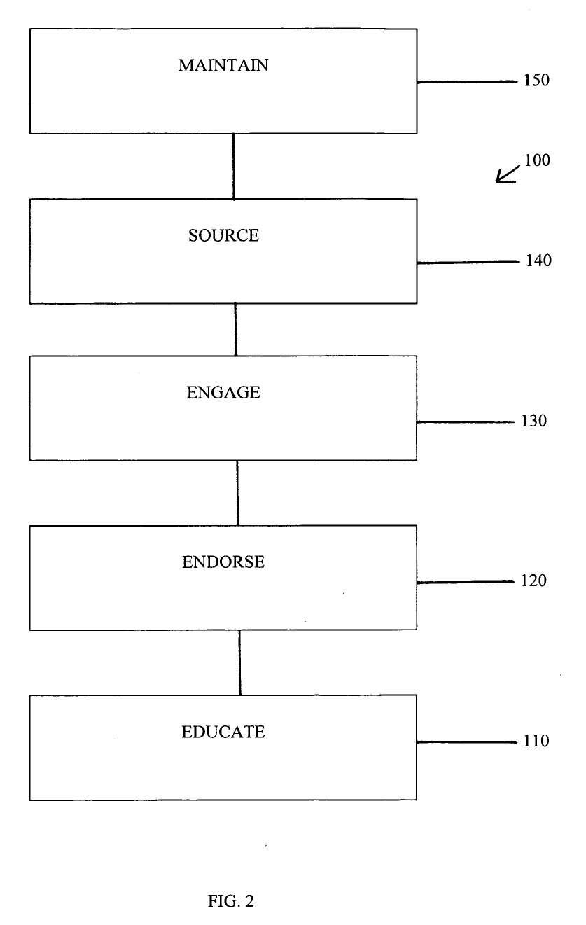

In a second preferred embodiment 100 of the present invention, FIG. 2, an educating step 110 is added. The focus of the educating phase or step is to educate entities, which include but are not limited to company representatives in any given industry about the general opportunities presented by sustainable business practices. This step may also include educating company representatives about specific opportunities related to targeted sustainable product development efforts in their industry.

The participants in the education step include but are not limited to representatives from companies where the waste streams are generated (supplier companies), representatives from companies that serve as headquarter operations over the companies where the waste streams are generated (parent companies), representatives from companies that purchase products from the companies where the waste streams are generated (master companies) and representatives from companies that support cross-industry product development (cross-industrial development partnership companies). This approach is taken in order to maximize influence within the given industry towards sustainable product development.

The activities of the educational phase include but are not limited to promoting the awareness of related sustainable product development opportunities and objectives as well as methods to create and implement the supportive organizational structure necessary for sustainable product development in the given industry.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A sustainable product solution development method comprising:
endorsing a waste stream supply;
engaging said endorsed waste stream supply to identify sustainable product targets;
sourcing said sustainable product targets into sustainable product solutions; and
maintaining said sustainable products solutions.

2. The method of claim 1 wherein reports are generated for said endorsed waste steam supply.

3. The method of claim 1 further including endorsing the waste stream supply of a generator entity.

4. The method of claim 3 further including the step of educating said generator entity.

5. The method of claim 1 wherein endorsing a waste stream supply includes locating available waste stream sources and forecasting waste stream supply from said sources.

6. The method of claim 5 further including determining waste stream properties.

7. The method of claim 6 wherein said waste stream properties include material, color or form.

8. The method of claim 1 wherein said sustainable product solutions are consumers of said waste stream supply.

9. The method of claim 1 wherein said sustainable product solutions are consumers of said waste stream supply.
